(19) United States
(12) Patent Application Publication
(10) Pub. No.: US 2025/0138827 A1
(43) Pub. Date: May 1, 2025

(54) METHODS AND APPARATUS FOR PROCESSING INSTRUCTIONS

(71) Applicant: Arm Limited, Cambridge (GB)

(72) Inventors: John David Robson, Cambridge (GB); Edvard Fielding, Trondheim (NO); Kalyani Rajkumar, Cambridge (GB); Philip Michael Watts, Chelmsford (GB)

(73) Assignee: Arm Limited, Cambridge (GB)

(21) Appl. No.: 18/927,890

(22) Filed: Oct. 26, 2024

(30) Foreign Application Priority Data
Oct. 31, 2023 (GB) 2316638.2

(51) Int. Cl. G06F 9/30

(52) U.S. Cl. CPC G06F 9/3016

(57) ABSTRACT

A computer implemented method for processing instructions in a multiprocessing apparatus comprises obtaining a first instruction of a first process; decoding the first instruction to detect a continuation indicator associated with the first instruction; determining whether or not to enforce the continuation indicator; and when it is determined to enforce the continuation indicator: continuing to execute the first process until completion of the first instruction and at least a next sequential second instruction of the first process. The continuation may temporarily suppress a normal eviction process based on a fairness algorithm, for example.

### TECHNICAL FIELD

The present technology relates to data processing and data processing apparatuses and systems.

### BACKGROUND

In data processing systems (e.g., a CPU or a graphics processing system (GPU)), a number of software processes (e.g., warps, where a warp may comprise one or more threads, and where a thread may comprise a piece of work) requiring access to a hardware resource(s) on the GPU may be required to run substantially simultaneously where a scheduler is provided to select the processes to access the hardware resources in a fair manner.

The present technology relates to the control of processes in such multiprocessing apparatus. The technology is in particular applicable to multiprocessing apparatuses which have a main processor (the execution engine) and attached co-processors (texture-mapper, load/store unit, ray-tracing unit, varying unit etc.). The main processor assigns tasks to the co-processors by, in one example of the technology, sending messages to them over a communications channel, such as a message-fabric, the messages comprising the necessary input data and a description of the task to be performed (opcode, control data). The co-processors will respond at a later time with the results of the tasks performed. In the meantime, the main processor could proceed to execute instructions from the same or different processes until it reaches an instruction which depends on the result of the aforementioned message-instruction (instruction performed by a co-processor on the message-fabric). In this example of a multiprocessing technology, messages are sent by “a message instruction unit”. The present technology applies to what happens to a process after a message has been sent—whether, and in what circumstances, the process is evicted from the execution engine (and the execution engine switched to running instructions from a different process) or whether, and in what circumstances, execution of the same process continues with the next instruction.

### SUMMARY

According to a first technique there is provided a computer implemented method for processing instructions in a multiprocessing apparatus, the method comprising: obtaining a first instruction of a first process; decoding the first instruction to detect a continuation indicator associated with the first instruction; determining whether or not to enforce the continuation indicator; and when it is determined to enforce the continuation indicator: continuing to execute the first process until completion of the first instruction and at least a next sequential second instruction of the first process.

According to a further technique there is provided a multiprocessing apparatus operable to process instructions, comprising: a receiver component for obtaining a first instruction of a first process; a decoder component to decode a first instruction of a first process to detect a continuation indicator associated with the first instruction and to determine whether or not to enforce the continuation indicator thereof; and an eviction suppressor component to, when it is determined to enforce the continuation indicator, suppress eviction of the first process from the message instruction unit to continue processing until completion of the first instruction and at least a next second sequential instruction of the first process.

According to a further technique there is provided a computer program comprising computer program code to, when loaded into a processor and executed thereon, cause the processor to perform the method as described above. The computer program may be implemented as a non-transitory data carrier carrying code which, when implemented on a processor, causes the processor to carry out the methods described herein.

In yet a further technique, the present invention may be implemented by way of a computer program operable to adapt a host processing system to provide an execution environment permitting operation of non-native processor instructions to perform the steps of the method as described above.

### BRIEF DESCRIPTION OF THE DRAWINGS

The techniques are diagrammatically illustrated, by way of example, in the accompanying drawings, in which:

FIG. 1A schematically shows a simplified block diagram of a multiprocessing system in accordance with an embodiment;

FIG. 1B shows a simplified example of a data processor operable to process warps comprising threads, in accordance with an implementation of the present technology;

FIG. 2 illustratively shows a block diagram of execution engine of graphics processing unit;

FIG. 3 illustratively shows a block diagram of execution engine of graphics processing unit in accordance with an embodiment;

FIG. 4 shows one possible structure of an instruction fetch stage; and

FIG. 5 schematically shows an example flow diagram for processing instructions at the execution engine of FIG. 3.

### DETAILED DESCRIPTION

As described above, in data processing systems, a number of software processes requiring access to a hardware resource(s) on the GPU may be required to run substantially simultaneously, where a scheduler is provided to select the processes to access the hardware resources, typically using an algorithm to select processes in a fair manner.

The data processing systems may include CPUs and various forms of accelerators, such as, for example, co-processors, graphical processing units, and the like.

In one example of the interactions of a system in which the present technology may be implemented, components, such as a CPU, a display controller and GPU may be connected to an interconnect. The CPU executes an application that requires graphics processing operations to be performed by the GPU. To do this, the application generates API calls that are interpreted by a GPU driver (on the CPU) that is operable to control the GPU. The driver executing on the CPU generates commands, data structures and instructions to the GPU, where, for example, a shader core may be activated to perform graphics processing operations using an execution engine. In an example implementation, graphics processing operations may be executed as warps, or bundles of threads, in a system of execution lanes in the execution engine, where each thread of a warp is executed by an execution lane.

The present technology thus relates to the control of processes in such multiprocessing apparatuses. The technology is in particular applicable to multiprocessing apparatuses which have a main processor (the execution engine) and attached co-processors (texture-mapper, load/store unit, ray-tracing unit, varying unit etc.). The main processor may assign tasks to the co-processors by, for example, sending messages to them over a message-fabric, the messages comprising the necessary input data and a description of the task to be performed (opcode, control data). In other architectures, the task assignments may be passed using other communication techniques.

The co-processors will respond at a later time with the results of the tasks performed. In the meantime, the main processor could proceed to execute instructions from the same or different processes until it reaches an instruction which depends on the result of the aforementioned message-instruction (instruction performed by a co-processor on the message-fabric). Messages are sent by “a message instruction unit”. The present technology applies to what happens to a process after a message has been sent—is the process evicted from the execution engine (and the execution engine switched to running instructions from a different process) or does execution of the same process continue with the next instruction.

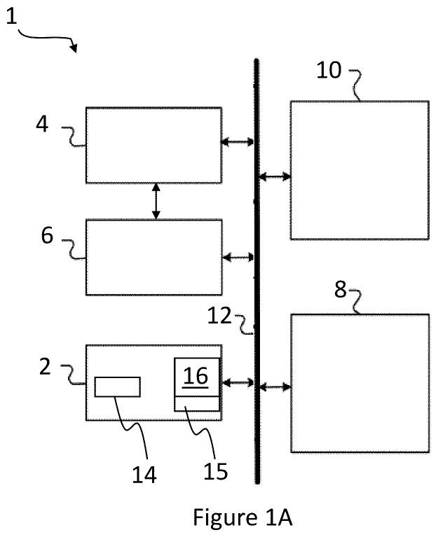

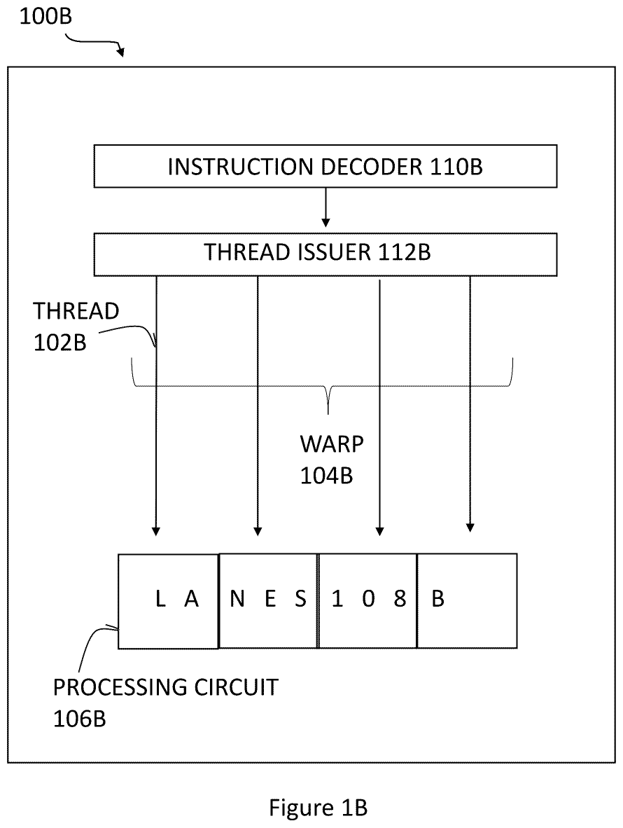

FIG. 1A is a simplified block diagram of a multiprocessing system 1. In the present embodiments multiprocessing system (hereafter “data processing system”) means a data processing system having one or more hardware (HW) units (e.g., functional units) to which two or more software (SW) processes may require access (i.e., the number of HW units is less than the number of SW processes.)

Data processing system 1 includes a number of processing units, which in FIG. 1A are depicted as host processor 2 and target processor units, depicted here as graphics processor unit (GPU) 4 and Neural Processing Unit (NPU) 6. Data processing system 1 also includes storage 8, such as random-access memory, and storage device 10, such as a solid-state drive, hard disc or other non-volatile storage. The elements of data processing system 1 are connected via an interconnect 12, which may be a coherent interconnect, a network, or bus, for example.

The host processor 2 may comprise, for example, a general-purpose processing core, and is herein referred to as a central processing unit (CPU 2).

GPU 4 executes a graphics processor pipeline that includes one or more processing stages (“shaders”). For example, a graphics processor pipeline being executed by GPU 4 may include one or more of, and typically all of: a geometry shader, a vertex shader and a fragment (pixel) shader. These shaders are programmable processing stages that execute shader programs on input data to generate a desired set of output data.

In order to execute shader programs, GPU 4 includes one or more graphics execution units or execution engines for executing the graphics programs (e.g., shader programs). GPU 4 may comprise one or more execution engines.

The actual data processing operations that are performed by the execution engines when executing a graphics program may be performed by respective graphics processing or functional units (circuits), such as arithmetic units (circuits), in response to, and under the control of, the instructions in the (shader) program being executed. Thus, for example, appropriate graphics functional units, such as arithmetic units, will perform data processing operations in response to and as required by instructions in a (shader) program being executed.

When executing an instruction in a graphics program, the execution engines (e.g. using the appropriate graphics functional unit, such as an arithmetic unit), will typically perform a processing operation using one or more input data value(s) to generate one or more output data value(s), and then return the output data value(s), e.g. for further processing by subsequent instructions in the program being executed and/or for output (for use otherwise than during execution of the program being executed).

The input data values to be used when executing the instructions will typically be stored in storage (e.g., a register file, or possibly a cache or caches accessible to the execution engine), and the output data value(s) generated by graphics functional unit(s) executing the instruction will correspondingly be written back to an appropriate storage (e.g., the register file), for future use. Thus, when executing an instruction, the input data value(s) will be read from an appropriate storage (e.g., the register file), and output value(s) written back to that same or different storage. Typically, the data structures used to represent the data to be used for processing (e.g., the input data array, the filters, the output data array, etc.) is multi-dimensional (e.g., 2D or 3D) image data.

NPU 6 typically comprises one or more neural execution units (hereafter “neural engine(s)”), where a neural engine is configured for more efficiently performing neural network processing operations of a particular type or types.

A neural engine may comprise one or more neural functional unit(s) to perform neural network operations. For example, a neural engine configured to perform tensor arithmetic operations, such as tensor MAC operations, may comprise a plurality of neural functional units in the form of multiplier-accumulator circuits (“MAC units”) which are arranged to perform such MAC operations on tensor data structures. Typically, the data structures used to represent the data to be used for neural network processing (e.g., the input data array, the filters, the output data array, etc.) are multi-dimensional (e.g., 4D+ tensors). The arithmetic operations thus typically comprise tensor arithmetic, e.g., tensor multiplication, addition, and so on.

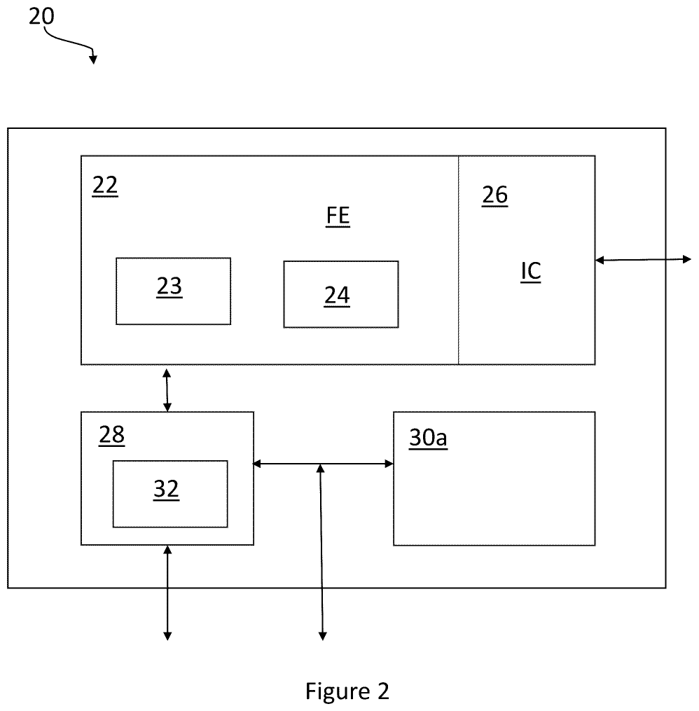

The NPU 6 may be coupled to, or, as depicted in FIG. 2, integrated into the GPU 4 to provide neural processing capabilities for the GPU 4, whereby in embodiments each execution engine of the GPU may have its own dedicated neural engine to provide neural network capabilities therefor. Alternatively, each execution engine of the GPU may share a neural engine of the NPU 6 with one or more other GPU execution engines, with one neural engine providing neural network capabilities for each GPU sharing that neural engine.

An application 14, such as a game, executing on a host processor 2 may require graphics processing operations to be performed by an associated graphics processing unit (graphics processing pipeline). To do this, the application will generate API (Application Programming Interface) calls that are interpreted by a driver 16 that is running on the host processor 2 to generate appropriate commands to the graphics processor 4 to perform operations required by the application 14. To facilitate this, a set of “commands” will be provided to the GPU 4 in response to commands from the application 14 running on the host system 2 for graphics output.

A program (e.g., a shader program) to be executed by the GPU 4 will be provided by the application 14 that requires the graphics processing using, for example, a high-level shader programming language, such as GLSL, HLSL, OpenCL, etc. The program is then translated by a compiler 15 (e.g., shader language compiler) of the driver 16 to binary code for the GPU 4. This binary code comprises a process having “instructions” which are specified in the instruction set specification for the given GPU 4. The compilation process for converting the program to binary code instructions may take place via a number of intermediate representations of the program within the compiler. Thus, a program written in a high-level language (e.g., shader language) may be translated into a compiler specific intermediate representation (and there may be several successive intermediate representations within the compiler), with the final intermediate representation being translated into the binary code instructions for the target GPU.

In one example, shown here as FIG. 1B, the technology described herein may be implemented in a data processor 100B, such as a graphics processing unit, which can execute execution threads 102B to execute a set of instructions for a program to perform data processing operations on data values, and in which threads 102B that are to execute the instructions of a program may be grouped together into thread groups (“warps”) 104B, with the execution threads 102B of a warp 104B executing instructions of a program in lockstep, e.g. such that each execution thread 102B within a warp 104B executes the same instruction (to perform a processing operation) in the program before the next instruction in the program is executed (and so on). The data processor 100B (e.g. graphics processing unit) includes an instruction execution processing circuit 106B which is configured as a plurality of execution lanes 108B, an instruction decode circuit 110B, and an execution thread issuing circuit 112B which issues execution threads 102B of warps 104B to the execution lanes 108B for execution. As will be clear to one of ordinary skill in the art, this arrangement is merely an example, and is one of many possible arrangements for data processing, and the present technology is in no way limited to such environments.

FIG. 2 illustratively shows a block diagram of execution engine 20 of graphics processing unit.

Execution engine 20 comprises one or more hardware units or blocks and in the present illustrative example, the execution engine 20 comprises a front-end control unit 22 (hereafter “front-end unit”) having a work queue 23 and scheduler 24 and where the execution engine 20 is coupled with instruction cache 26. The work queue 23 may be a first-in-first-out queue although the claims are not limited in this respect.

Execution engine 20 further comprises a message instruction unit or message block 28 for executing message instructions and one or more processor unit(s) 30a-n for executing arithmetic instructions (e.g., Fused Multiply-Add instructions (FMA); convert (CVT) instructions; special function unit (SFU) instructions).

It will be appreciated that the execution engine 20 may comprise additional and/or alternative hardware units to those depicted in FIG. 2. For example, the execution engine 20 may comprise a divergence unit (not shown) which may be used to manage program counters for branch cases.

The various hardware units may communicate with one another and may communicate with SW processes and/or HW units external to the execution engine 20. For example, the front-end unit 22 is to receive work (e.g., from a warp manager (not shown)) and is, using the scheduler 24, to schedule and distribute work in the work queue 23 to the message block 28 and processing units 30a-n to be executed. Whilst the embodiments hereafter primarily describe the scheduling and processing of message instructions, it will be appreciated that the scheduler 24 may also schedule other types of instructions (e.g., arithmetic), or a different scheduler may be provided to schedule messages other than message instructions.

In the present illustrative embodiments, a message instruction is an instruction which, when executed at the message block 28, results in work requests sent over a message fabric interconnect to various target client units (e.g., hardware accelerators such as texture mapper unit and varying unit or other units such as the Load/Store Cache (LSC)). Such work requests may comprise requests for the target client unit to perform a requested operation.

Scheduler 24 may employ a fairness selection mechanism to select, e.g., from work queue 23, processes to be run (i.e., where an instruction from the process is executed at message block 28) in a non-biased manner, where a typical fairness selection mechanism (i.e., that is not biased towards any particular process) ensures that one instruction is executed from each process in turn.

When a process is selected and issued to the message block (MB) by the scheduler (24), the MB will issue an instruction fetch request to the instruction cache (26) for this process. Instruction cache will respond to the MB with instructions. The instruction received will be executed and further continuing decisions for this process are made based on the continuation indicator on the received instruction.

The L0 cache (32) inside the MB will store instructions fetched from the instruction cache (26) along with the type of the next sequential instruction of the fetched instruction. There are other storage elements (relatively small) in the MB that store information pertaining to the process/warp including warp ID (to identify the process), warp type (used for fault detection), discarded lanes of the warp, pointer of the instruction in the instruction cache cacheline (to issue instruction fetch requests), etc. This information is reused by the continuing instructions of a particular process until it is evicted.

The process is evicted from the MB soon after the operands of the current instruction are fetched from the register file; i.e., eviction of the process does not depend on the results being written to the register file. It only needs to make sure that the dependencies for the process have been incremented in the FE (22). After eviction, the instruction will proceed to create request messages on the message fabric interconnect. The results come back after some time and get processed by the MB and dependency gets decremented.

When message block 28 completes execution of the current instruction of the selected process, the results may be, for example, written to storage (e.g., register files) in the processor units 30a-n and the process is then “evicted” from the message block 28, whereby the process is returned to the work queue 23 to be selected by the scheduler in accordance with the non-biased selection mechanism. In the present embodiments eviction may also comprise deleting state data relating to the process at the message block 28 and/or data in data storage (e.g., data cache) at the message block 28 required by the message block 28 to process the instruction.

Using the non-biased selection mechanism avoids deadlocks and allows all processes in the queue to move forward to completion. However, such a non-biased fairness mechanism may result in inefficient processing. As an example, inefficient processing happens due to cache thrashing of a client unit of the MB, e.g.: texture mapper, due to large delays between sending messages of subsequent instructions of the same process from MB to the client unit. This is caused due to the fairness mechanism.

As an illustrative example, cache thrashing may happen at the client unit, in one example case, the texture mapper unit. For example, if a shader has 4 back to back texturing instructions, the current scheduler will not schedule them one after the other because of the fairness mechanism (one instruction from one process). On the client side, the delay between receiving the 4 texturing instructions' messages, causes TEX cache thrashing and the data required to process the TEX instruction in the TEX unit has to be fetched 4 times. Embodiments of the present invention address this issue by trying to process the 4 instructions back to back in the MB, thereby reducing the delay between the messages sent for the instructions of the same process to the client.

The present technology is described herein with reference to the use of a message block. However, as will be clear to one of skill in the art, the present technology is operable in other architectures not having message blocks.

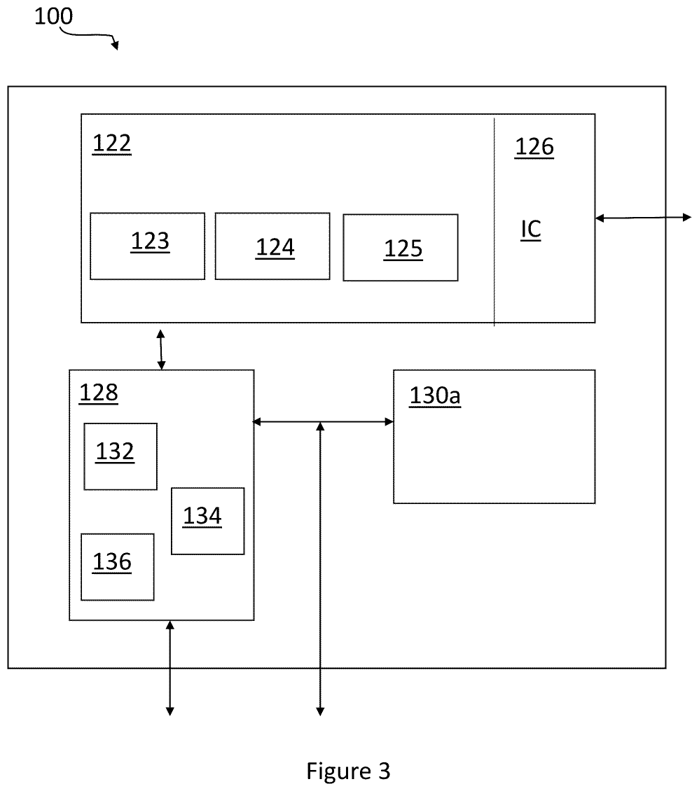

FIG. 3 illustratively shows a block diagram of execution engine 100 in accordance with the present techniques. Like numbering will be used to describe like features above.

The message block 128 of the execution engine 100 comprises a decoder component 134 and eviction suppressor component 136. A message block 128 may also comprise an interface to/from the instruction cache 126 to communicate therewith, and further comprises an interface to/from the front-end unit 122 to communicate therewith, and an interface to/from the processor units.

In the present embodiments, a modifier indicator or continuation indicator (e.g., a specified value or flag) is encoded within the instructions received at the front-end (e.g., within binary code instructions). In the present illustrative example, the continuation indicator (CI) comprises a 1-bit value (e.g., ‘0’ or ‘1’), which, when set, is indicative of how the execution engine 100 is to function. For example, when the CI is set (e.g., ‘1’) the execution engine 100 may function in a different manner compared to when the CI is not set (‘0’). It will be appreciated that the CI may is not limited to being a 1-bit value and may take any form.

The CI may be set by the compiler, where the compiler may use various heuristics to determine whether or not to set the CI. Additionally, or alternatively, the value of the CI may be defined in the high-level shader program itself and translated by the compiler, where a programmer may define the CI by direct intervention (e.g., for safety critical code or library code).

Typically a heuristic will need to predict if the next instruction is likely to hit the same line in a cache as the first instruction. One example in a GPU is the texture-cache which holds image-data. Typically a cache-line will hold a rectangular region of pixels, for example 4×4. If a program does multiple texture-reads from the same image/texture it has been seen to frequently be the case that these reads are close together on the image and would be likely to hit the same cache-line. So one heuristic is to set the CI for consecutive texturing-instructions which read from the same texture. If they read from different textures, on the other hand, the CI should not be set. Another example would be for consecutive memory loads where the compiler can infer that the memory addresses are close together, such as would be the case for a MEMCPY for example.

On receiving an instruction in where the CI is set (i.e., the instruction does have an associated CI), the execution engine 100 may function differently than it otherwise would have had the CI not been set (i.e., the instruction does not have an associated CI).

In some embodiments the CI is determinative, and the execution engine 100 always functions in accordance with the value of the CI. In other embodiments, the CI is indicative or informative, and the execution engine 100 may function in accordance with the value of the CI or may choose to ignore the value of the CI as will be described in detail below.

On receiving a workload comprising code from the driver on the host processor (not shown in FIG. 3), the code comprising a plurality of processes, is stored in work queue 123.

Scheduler 124 determines whether the next process in the work queue 123 comprises instructions required to be issued to the message block 128 (e.g., message instructions which may require data from an external client unit) or instructions required to be issued to the processing units 130a-130n for internal processing (e.g., arithmetic instructions which do not perform external fetching).

When a process comprising message instructions is selected by the scheduler 124, the scheduler 124 issues or dispatches the selected process to the message block 128.

State information relating to the process and dependency information (e.g., if an instruction is dependent on the result of another instruction) may be stored in process information storage 125 which may be updated by, for example, the message block 128 or scheduler 124 or any other appropriate unit. Each instruction in an instruction stream will create dependencies for the warp on execution. This is achieved by incrementing dependency slots allocated to the process. Each instruction executed by the warp will use a specific slot (e.g. TEX_FETCH).

For example, one or more dependency counters may be maintained in the process information storage 125, where each instruction executed in the message block 128 creates dependencies for the process (e.g., where a first instruction of the process may depend on a result of a second instruction of the process before it can complete). The dependencies may be tracked by the dependency counter(s), where the dependency counter(s) are incremented on execution of an instruction and decremented when a client unit (texture mapper, varying unit, LSC unit) returns a result.

An instruction fetch component (not shown in FIG. 3) in the message block 128 issues a fetch request to the instruction cache 126 and receives the current instruction for that process to be executed and stores the instruction in local storage 132. The message block 128 also receives, for example from the instruction cache 126 during the fetch operation, additional information with the current instruction that will provide details about at least the next instruction in the process. Such additional information may indicate or may be used to determine, for example, the type of the next instruction or next two or more instructions; whether an instruction link for an instruction (pointer of the instruction in the cache line) reaches the end of the cache line; whether a termination condition is decoded in the current instruction (This information is decoded from the instruction itself after the fetch response is received in the MB from the IC.); or whether a front-end dependency condition is about to overflow; and the priority level of the instruction. For the dependency condition, the current value of the dependency counter is received on warp issue from the FE to MB. This is incremented internally each time a valid continue instruction is fetched. We stop continuing when it reaches its maximum value (fixed dependency resources available for each process).

In a further example, the additional information may be the type of the next instruction. For example, if there are three different pipelines in the MB to process LSC, VAR and TEX instructions, we treat this as three different instruction types. The additional information will indicate which pipeline the next instruction is intended for. If it is different than the pipeline that the current instruction is executing, the continuation indicator will be ignored. The instruction link (pointer of instruction in the cacheline) is received on warp issue from the FE to MB. This is incremented internally each time a valid continue instruction is fetched. In this instance, continuation is stopped when it reaches the maximum value (end of cacheline).

A program counter (not shown) may also be updated by one or more units to track the progress of the instructions of the program as they are fetched.

The decoder component 134 (a pre-decode unit inside the instruction fetch stage of the MB) decodes the current instruction to determine whether or not a continuation indicator is associated with the instruction. The additional information may be provided pre-decoded or may be required to be decoded.

When a continuation indicator is not associated with the instruction (i.e., when there is no continuation indicator or the value is set to indicate that the process should be evicted from the message block when the instruction completes), the message block will evict the process after execution of the instruction completes, and the process is evicted from the message block 128, whereby the process is returned to the work queue 123 to be selected by the scheduler 124 in the future. As above, eviction may also comprise deleting state data relating to the process at the message block 128 and/or data in data storage at the message block 128 required by the message block 128 to process the instruction. Eviction may also include updating the program counter at the front-end unit 122.

When a continuation indicator is associated with an instruction (i.e., when the value is set to indicate that the process should not be evicted from the message block when the instruction completes), an eviction suppressor component 136 may suppress evicting the process from the message block after execution of the instruction completes i.e., where the process is not returned to the work queue 123. If the eviction is suppressed in this way, the message block 128 will then decode at least a next sequential instruction of that process.

When a continuation indicator is not associated with the next sequential instruction, the message block 128 will evict the process after the next sequential instruction completes.

When a continuation indicator is associated with the next sequential instruction, the eviction suppressor component 136 may suppress evicting the process from the message block 128 after the next sequential instruction completes, and the message block can continue to execute the next instruction from the same process. Similar functionality may apply to further sequential instructions of the process having a continuation indicator, where eviction of the process will be suppressed until an eviction point is reached.

An eviction point may be reached when the current instruction being executed does not have an associated continuation indicator.

As above, the continuation indicator may only be indicative of how the message block should function, such that even when a continuation indicator is associated with a particular instruction, the message block 128 may evict the process after the instruction completes dependent on various factors. For example, an eviction point may be met when the current instruction does have an associated continuation indicator but where the instruction link reaches the end of the cache line (The instruction link is effectively the pointer to the instruction in the FE cacheline. This is received on warp issue from the FE to MB. The value of the link will be incremented in the MB each time a valid continue instruction is fetched and decoded from the IC. Therefore, continuation is stopped when the maximum number of instructions in IC cacheline have been executed.)_In further examples, an eviction point may be reached where the current instruction and the next instruction are different types (e.g., to be sent to different client units (e.g. LSC unit vs VAR unit); where a termination condition is decoded in the current instruction; or where a dependency condition is not met. An example dependency condition may be where each process is allocated limited resource in the message block 128, so when a particular process is determined to exceed a threshold for that resource, then any instructions of that particular process having associated continuation indicators will be evicted after being processed even when those instructions have an associated continuation indicator. As an illustrative example, the front-end unit may send a dependency count to the message block, where the dependency count may be used to calculate the minimum headroom available in the dependency counter in storage 125 for a process issued to the message block 128. An eviction point will be reached (i.e., a continuation indicator will not be enforced for that process) if it is determined that the headroom is/will be exhausted when fetching/executing an instruction for that process.

In embodiments, honoring the continuation indicators (i.e., suppressing eviction of a process even after the current instruction completes) may cause performance issues, and the message block 128 may disregard continuation indicators in certain instructions that are known to result in such performance issues (e.g., malfunctions in the hardware such as stalling, crashing). Additionally, or alternatively, the operation of the compiler may be modified to avoid including continuation indicators in certain types of instructions to avoid any performance issues.

Furthermore, the compiler may have access to information about which application is running and could use a particular heuristic to determine whether or not to include continuation indicators in or more of the instructions whilst that application is running. Furthermore still, there may be one or more instances of the compiler with variant ways of operating depending on the programs that are being compiled. Such functionality may provide for tailored compilation depending on the programs being run.

The message block 128 may also determine whether or not dependency overflow is met and may only continue honoring the continuation indicator of a current instruction of a process if a dependency overflow condition for that process is met or where a dependency counter has not reached a defined limit. For example, the dependency counter (not shown) may be maintained in the front-end 122 (e.g., in process information storage 125), where the dependency counter is incremented after all the operand fetching is done for an instruction each time a process is issued to the message block 128 and a request issued to a client unit as result of a current instruction being executed, and decremented when the required results are returned for the instruction of that process being executed.

Furthermore, the additional information may indicate a priority level of the instruction, where the message block may enforce the continuation indicators for instructions having a higher level of priority more often than instructions having a lower level of priority when the continuation indicator is indicative of how the message block should execute the instructions.

In these implementations, a balance can be sought between the benefits of honoring the continuation indicator and the benefits of retaining the fairness algorithm. The decision process may be implemented, for example, using a trained machine-learning and inferencing engine that is capable of comparing weightings associated with the proposed processing paths to determine the likely best outcome.

The compiler on the host processor (not shown) may use heuristics when determining whether or not to modify an instruction to add a continuation indicator thereto. In addition to, or as an alternative to, using heuristics, the compiler could also add a continuation indicator based on characteristics of the instructions themselves. For example, when a first instruction of a process and a next sequential instruction of the process will not read from the same memory region (e.g., the same image), then the compiler will not set the continuation indicator for the first instruction.

As above, the execution engine 100 may be configured to treat the continuation indicator as determinative (where the execution engine 100 always acts in accordance with the value of the continuation indicator) or the execution engine 100 may be configured to treat the continuation indicator as informative or indicative (where the execution engine 100 can determine whether or not to act in accordance with the value of the continuation indicator). Even when the execution engine 100 is configured to treat the continuation indicator as informative/indicative then the message block 128 may, in some circumstances, evict an instruction after completion although that instruction has a continuation indicator associated therewith.

It will be appreciated that the message block 128 may conceptually comprise one or more processing pipelines, where each pipeline is to process instructions of the different types of processes issued to the message block 128. For example, a first pipeline may process texture instructions resulting in work requests for the texture mapper unit (a texture mapper pipeline), a second pipeline may process LSC instructions resulting in work requests for a LSC unit (a LSC pipeline); and a third pipeline may process varying instructions resulting in work requests for the varying unit (a varying pipeline).

Each pipeline may comprise one or more processing stages to process the instructions.

As an illustrative example, a fetch stage may comprise components to receive the processes issued by the front-end and to fetch the instructions thereof.

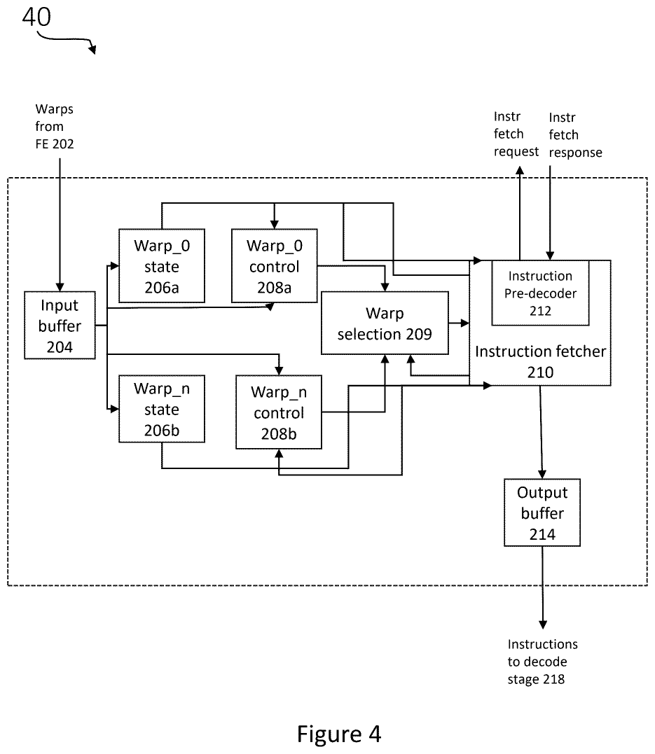

FIG. 4 shows one possible structure of a message block instruction fetch stage 40. In FIG. 4, warps from FE arrive at an input buffer 204, after which warp state entities 206a, 206b and warp control entities 208a, 208b feed in to warp selection 209. The warp selection is then passed to the instruction fetcher 210 to fetch the instructions. In one example of the present technology, an instruction pre-decoder 212 then intercepts the incoming instructions and determines whether there is a continuation indicator before passing the relevant information via the output buffer 214 to the decode stage 218.

A decode stage 218 may determine the operation to be executed, whilst in a further “operand fetch stage” the operand data of the decoded instruction are fetched, for example, from the one or more of the processing units 130a-n and may be stored in storage at the message block (e.g., in data cache at the message block).

In a further stage (not shown), work requests may be sent via a message fabric interconnect to one or more client units to undertake requested work in accordance with the instruction.

When the client unit performs the requested work, the result returned from the client unit(s) is processed at a “writeback stage”, with the results data written to appropriate storage (e.g., one or more caches and/or register files) in accordance with the instruction.

In embodiments there may be a latency (e.g., a multi-cycle latency) for an instruction response from instruction cache 126 following a fetch request from the message block 128. Therefore, fetching and executing instructions for the same process back-to-back in the message block 128 may result in “bubbles” or a delay or latency in the pipeline used to execute the instruction.

The present techniques provide for mitigating the latency by providing a fetch stage where two or more processes may be in-flight at the same time.

FIG. 4 thus shows an illustrative example of a fetch stage 40 which can handle two or more processes substantially concurrently.

The fetch stage 40 described above allows for a current instruction and a next sequential instruction of the same process to be fetched (e.g., from storage (e.g., instruction cache) at the front-end), where it can be determined whether the current instruction has a continuation indicator associated therewith, and an eviction scenario may be identified to prevent the continuation indicator being honored (e.g., if the current instruction and the next instruction are different types).

The fetch stage 40 also allows for eviction scenarios to be identified, for example based on the additional information received from the front-end.

The fetch stage 40 also allows for a plurality of different processes to be in-flight in the message block at any one time, thereby reducing the effects of latency when fetching instructions from the front-end.

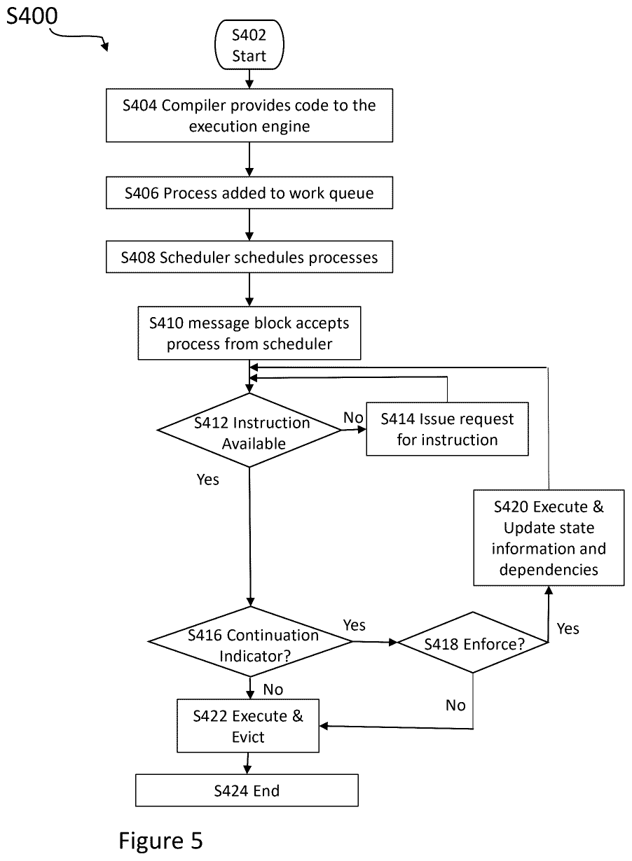

FIG. 5 schematically shows an example flow diagram 400 for processing instructions at the execution engine of FIG. 3.

At S402 the flow diagram 400 starts.

At S404 a compiler (e.g., shader language compiler) translates a high-level program to provide binary code for a process comprising “instructions” to the execution engine, where the instructions are specified in the instruction set specification for the GPU comprising the execution engine. The compiler may encode a continuation indicator into one or more of the instructions based on or in response to one or more heuristics and/or in response to one or more characteristics of the instructions or the application running on the host processor.

At S406, a process is added to a work queue on a front-end unit of the execution engine, where the work queue comprises all processes which are to be executed by the execution engine.

At S408, a scheduler in the front-end selects the processes to issue to the message block and the processing units. Selection of the process may be based on a first-in-first-out order, where the work queue may be a FIFO queue.

At S410 the message block accepts a process issued from the front-end.

At S412, the message block checks if the current instruction for that process is in local storage (e.g., L0 cache), and when the current instruction for that process is not available in local storage, then the message block at S414 issues an instruction fetch request to the front-end (e.g., to instruction cache at the front-end).

When at S412 the instruction is available, a decoder component (e.g., depicted as the pre-decoder component in FIG. 4) of the message block decodes the fetched instruction and, at S416, detects whether the current instruction has a continuation indicator associated therewith.

When there is a continuation indicator associated with the current instruction, a suppressor component, at S418 determines whether to enforce or honor the continuation indicator. Such a determination may be based on, for example, the additional information received during the fetch operation, and may include for example as determination as to: whether the current instruction and the next instruction are different types (e.g., to be executed by different pipelines of the message block (e.g., a varying instruction vs LSC instruction); where a termination condition is decoded in the current instruction or where a front-end dependency condition is about to overflow; or where the next instruction is not available in local storage; and the priority level of the instruction.

When, at S418, the suppressor component enforces the continuation indicator, the message block, at S420, executes the instruction and updates the state information and/or dependency information and processes the next sequential instruction of the process. The next sequential instruction (and any further instructions) is (are) processed in the same manner as at S412 to S414 until an eviction point is reached for an instruction. The MB may also communicate with the front-end unit to prevent the scheduler issuing any further processes to the message block whilst the continuation indicator is being honored for the current process. The MB instruction fetch stage will back pressure the warp issue interface to the scheduler if MB is at capacity. Warp state registers 206a and 206b will not be deallocated until the continuation has stopped due to reaching an eviction point. New warps will only be accepted when the current warps are deallocated. When at S418, the suppressor component does not enforce the continuation indicator, the current instruction is, at S422, executed and at completion the process is evicted back to the work queue. The suppressor component may also communicate with the front-end unit to instruct the scheduler to issue the next process to the message block.

When at S416 the current instruction does have an associated continuation indicator the current instruction is, at S422, executed and at completion the process is evicted back to the work queue.

At S424 the flow diagram ends.

The present techniques provide a biased execution mechanism, where instructions of the same process are executed, and the process is retained in the message block rather than being evicted after each instruction completes.

Such functionality means that the data required by instructions of the same process is available to at least one subsequent instruction when it is executed rather than having to fetch the data (e.g., from cache) each time. This avoids thrashing of data caches and reduces energy consumption and improves overall execution speed.

Such functionality also means that the message block can determine, independently of the front-end, whether to execute successive instructions of a process rather than having to evict the process after executing each individual instruction of a process.

The functions of the various elements shown in the figures, including any functional elements labelled as a “block,” “component,” “module” or “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps or acts are in some way inherently mutually exclusive.

As used herein, the term “configured to,” when applied to an element, means that the element may be designed or constructed to perform a designated function, or has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed.

The techniques further provide processor control code to implement the above-described systems and methods, for example on a general-purpose computer system or on a digital signal processor (DSP). The techniques also provide a carrier carrying processor control code to, when running, implement any of the above methods, in particular on a non-transitory data carrier-such as a disk, microprocessor, CD- or DVD-ROM, programmed memory such as read-only memory (firmware), or on a data carrier such as an optical or electrical signal carrier. The code may be provided on a carrier such as a disk, a microprocessor, CD- or DVD-ROM, programmed memory such as non-volatile memory (e.g., Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™, VHDL (Very high speed integrated circuit Hardware Description Language) or SystemVerilog hardware description and hardware verification language. As the skilled person will appreciate, such code and/or data may be distributed between a plurality of coupled components in communication with one another. The techniques may comprise a controller which includes a microprocessor, working memory and program memory coupled to one or more of the components of the system.

The techniques discussed above may be implemented within a data processing apparatus which has hardware circuitry provided for implementing the instruction decoder and eviction controlling mechanisms discussed above. However, the same technique can also be implemented within a computer program which executes on a host data processing apparatus to provide an instruction execution environment for execution of target code. Such a computer program may control the host data processing apparatus to simulate the architectural environment which would be provided on a target data processing apparatus which actually supports target code according to a certain ISA, even if the host data processing apparatus itself does not support that architecture. Such simulation programs are useful, for example, when legacy code written for one ISA is being executed on a host processor which supports a different ISA. Also, the simulation can allow software development for a newer version of the ISA to start before processing hardware supporting that new architecture version is ready, as the execution of the software on the simulated execution environment can enable testing of the software in parallel with ongoing development of the hardware devices supporting the new architecture. The simulation program may be stored on a storage medium, which may be an non-transitory storage medium.

Hence, the computer program may comprise instruction decoding program logic which decodes program instructions of the target code to control the host data processing apparatus to perform data processing in response to the non-native program instructions (e.g. mapping each instruction of the target code to a sequence of one or more instructions in the native instruction set of the host which implements equivalent functionality). Also, the computer program may have register emulating program logic which maintains a data structure in host storage of the host data processing apparatus (e.g. in registers or memory of the host) to emulate the register storage of the target ISA being simulated, which one would expect to be provided in hardware in a processor actually supporting the target ISA.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended items.

1. A computer implemented method for processing instructions in a multiprocessing apparatus, the method comprising:
obtaining a first instruction of a first process;
decoding the first instruction to detect a continuation indicator associated with the first instruction;
determining whether or not to enforce the continuation indicator;
when it is determined to enforce the continuation indicator:
continuing to execute the first process until completion of the first instruction and at least a next sequential second instruction of the first process.

2. The method of claim 1, wherein continuing comprises suppressing an algorithmically predetermined eviction.

3. The method of claim 1, comprising:
decoding, with a decoder component, the second instruction of the first process to detect a continuation indicator associated with the second instruction;
determining, with the decoder component, whether or not to enforce the continuation indicator of the second instruction; and
suppressing eviction of the first process from an instruction unit until completion of the second instruction and at least a next sequential third instruction of the process responsive to a detected continuation indicator when it is determined to enforce the continuation indicator of the second instruction.

4. The method of claim 3, further comprising,
receiving, at the instruction unit from a control unit, the first process;
fetching, with a decoder component from the control unit, the first instruction for the first process.

5. The method of claim 4, further comprising: obtaining, from the control unit, additional information associated with the first instruction, where the additional information comprises one or more of: the position of the first instruction in cache;
the type of the current and next sequential second instruction; a termination condition; a dependency condition; a priority level for the first instruction.

6. The method of claim 5, comprising:
identifying an eviction point for the first instruction based on or in response to the additional information associated with the first instruction.

7. The method of claim 6, further comprising:
evicting the first process from the instruction unit at completion of the first instruction in response to the identified eviction point.

8. The method of claim 1, further comprising:
storing instructions of the first process and instructions of a second process in storage at a first pipeline stage;
issuing, to a second pipeline stage, the instructions of the first and second processes in an interleaved instruction stream.

9. The method according to claim 1, wherein the determining detects an “always continue” indication and always continues to execute the first process until completion of the first instruction and at least a next sequential second instruction of the first process.

10. The method of claim 1, further comprising:
storing instructions of the first process in a first storage at a first pipeline stage;
storing instructions of a second process in a second storage at the first pipeline stage;
selecting instructions from the first and/or second storage;
issuing, to a second pipeline stage, the selected instructions as an instruction stream for processing.

11. The method of claim 6, where evicting the first process from the instruction unit at completion of the first instruction comprises:
returning the first process to a work queue at the control unit for selection by a scheduler.

12. The method of claim 3, further comprising:
issuing, from the instruction unit, a work request to a client unit to perform the work request in accordance with the first instruction.

13. The method of claim 1, wherein when it is determined not to enforce the continuation indicator:
evicting the first process from the instruction unit at completion of the first instruction.

14. The method of claim 1, wherein when a continuation indicator is not detected:
evicting the first process from the instruction unit at completion of the first instruction.

15. The method of claim 13, comprising:
receiving, from the control unit, a further process when the first process is evicted.

16. The method of claim 1, where the continuation indicator is encoded in the instruction.

17. The method of claim 1, wherein at least one of the first and the second processes comprises a warp.

18. A multiprocessing apparatus operable to process instructions, comprising:
a receiver component for obtaining a first instruction of a first process;
a decoder component to decode a first instruction of a first process to detect a continuation indicator associated with the first instruction and to determine whether or not to enforce the continuation indicator thereof;
an eviction suppressor component to, when it is determined to enforce the continuation indicator, suppress eviction of the first process from the instruction unit to continue processing until completion of the first instruction and at least a next second sequential instruction of the first process.

19. A computer program comprising computer program code to, when loaded into a processor and executed thereon, cause the processor to perform the method of claim 1.

20. A computer program operable to adapt a host processing system to provide an execution environment permitting operation of non-native processor instructions to perform the method of claim 1.
